(19) United States
(12) Patent Application Publication
(10) Pub. No.: US 2016/0059789 A1
(43) Pub. Date: Mar. 3, 2016

(54) ARTICLE HOLDER SYSTEM AND VEHICLE CONSOLE INCLUDING THE SAME

(71) Applicant: Ford Global Technologies, LLC, Dearborn, MI (US)

(72) Inventors: MOHAMED HAMIEH, DEARBORN HEIGHTS, MI (US); SCOTT H. DUNHAM, REDFORD, MI (US)

(21) Appl. No.: 14/472,534

(22) Filed: Aug. 29, 2014

(51) Int. Cl. B60R 7/04; F16M 13/02; B60N 3/10

(52) U.S. Cl. CPC B60R 7/04; B60N 3/102; B60N 3/103; F16M 13/022

(57) ABSTRACT

In one or more embodiments, an article holder system includes a track unit, first and second holding wells supported on the track unit and movable along a first direction between a retracted position and an initially open position, at least one of the first and second holding wells movable between an extendedly open position and the initial open position along a second direction different than the first direction.

### TECHNICAL FIELD

The disclosed inventive concept relates generally to an article holder system and a vehicle console including the same.

### BACKGROUND

Vehicle consoles are often provided with cup holders and/or article storage. Certain existing designs for cup holders or article storage have been met with limited use for lack of flexibility in accommodating articles with particular sizes or dimensions. Users may attempt to place large cups in unsuitable cup holders and often experience unwanted liquid spills and hence unpleasant contamination of nearby surroundings, including clothing, flooring, and electrical devices that are often sensitive to liquids.

### SUMMARY

In one or more embodiments, an article holder system includes a track unit, first and second holding wells supported on the track unit and movable along a first direction between a retracted position and an initially open position, at least one of the first and second holding wells movable between an extendedly open position and the initially open position along a second direction different than the first direction.

The track unit may include a leg portion supporting movement along the first direction and a shoulder portion supporting movement along the second direction. The leg portion may include two legs supporting the shoulder portion. The two legs may be movable relative to each other along the second direction. At least one of the leg and shoulder portions may be telescopic.

At least one of the first and second holding wells may include a cup-holding cavity for holding a drinking cup and a storage slot spaced apart from the cup-holding cavity. The storage slot may be open to exterior on one side, or open to exterior on two opposing sides. The first and second holding wells may respectively include first and second storage slots, each of which having an opening facing each other to form a collective storage slot.

At least one of the first and second holding wells may be detachable from the track unit.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1 illustratively depicts a perspective view of an article holder system as positioned relative to a vehicle console according to one or more embodiments, wherein the article holder system is at an initially open position;

FIG. 2 illustratively depicts a perspective view of the article holder system referenced in FIG. 1, wherein the article holder system is at a retracted position;

FIG. 3 illustratively depicts a perspective view of the article holder system referenced in FIG. 1, wherein the article holder system is at an extendedly open position;

FIG. 4 illustratively depicts a top, alternative view of the article holder system referenced in FIG. 1, FIG. 2 or FIG. 3;

FIG. 5A illustratively depicts an alternative perspective view of the article holder system referenced in FIG. 3;

FIG. 5B illustratively depicts yet another perspective view of the article holder system referenced in FIG. 3;

FIG. 5C illustratively depicts yet another perspective view of the article holder system referenced in FIG. 3;

FIG. 6A illustratively depicts an alternative, partial perspective view of the article holder system referenced in FIG. 2;

FIG. 6B illustratively depicts a partial perspective view of the article view of the article holder system referenced in FIG. 6A;

FIG. 6C illustratively depicts an enlarged, partial perspective view of the article holder system referenced in FIG. 6A or FIG. 6B;

FIG. 6D illustratively depicts a rear view of a holding well of the article holder system referenced in FIG. 6A, FIG. 6B or FIG. 6C;

FIG. 6E illustratively depicts a rear view of another holding well of the article holder system referenced in FIG. 6A, FIG. 6B or FIG. 6C;

FIG. 7A illustratively depicts an alternative perspective view of a holding well referenced in FIG. 5A, FIG. 5B and FIG. 5C; and

FIG. 7B illustratively depicts a cross-sectional view of the holding well referenced in FIG. 7A.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

In one or more embodiments, the present invention is believed to be advantageous in at least providing an article holder system with holding wells that may move along a longitudinal direction between a retracted position and a an initially open position. Once at the initially open position, the holding wells may move relative to each other along a transverse direction such that a desirable distance may be obtained between the holding wells along the transverse direction.

In addition to providing support for beverage cups, the holding wells may be configured to include storage slots spaced apart from cup-holding cavities for supporting the beverage cups. The spaced apart storage slots may be made open to exterior at one or more sides to accommodate articles with relatively greater dimensions, and particularly planar articles with relatively big area-to-thickness aspect ratios.

The article holder system thus provided offers enhanced design flexibility in well size and well shape, and enhanced mechanical durability for article holding strength. Moreover, because of the design flexibility in well size, well shape and distance between the holding wells, the article holder system in one or more embodiments may readily accommodate articles with irregular shape or with extended dimensions, and articles to be held or stored are not limited to conventional drinking cups.

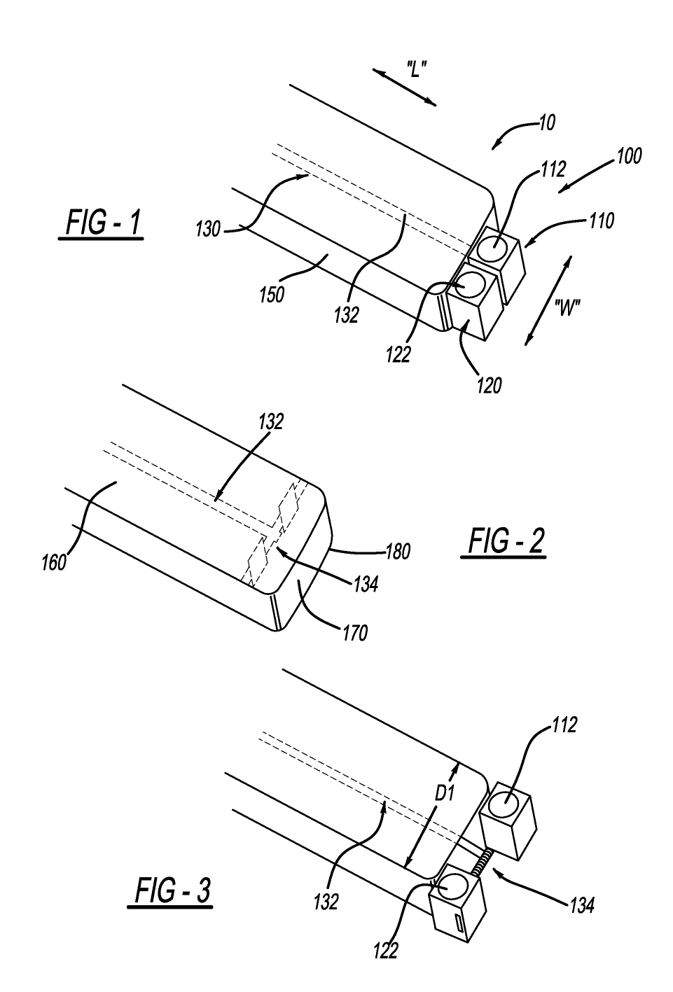

In one or more embodiments, and as illustratively depicted in FIG. 1, FIG. 2 and FIG. 3, an article holder system generally shown at 100 is operable at various positions, including a retracted position depicted in FIG. 2, an initially open position depicted in FIG. 1, and an extendedly open position depicted in FIG. 3. For brevity, the article holder system 100 is depicted as being positioned in relation to a housing 150 which in turn is part of a vehicle console 10; however, the article holder system 100 may be employed in any suitable environment within a vehicle or outside of a vehicle such as any residential or commercial seating arrangements.

Referring back to FIG. 1, FIG. 2 and FIG. 3, the article holder system 100 includes a track unit 130 shown at least partially received within the housing 150, first and second holding wells 110, 120 supported on the track unit 130 and movable along a first direction “L” between a retracted position such as one shown in FIG. 2 and an initially open position such as one shown in FIG. 1, at least one of the first and second holding wells 110, 120 movable between an extendedly open position such as one shown in FIG. 3 and the initially open position shown in FIG. 1 along a second direction “W” different than the first direction “L.”

Accordingly, the track unit 130 functions to guide a movement of the first and second holding wells 110, 120 along the first direction “L” and along the second direction “W.” To achieve this function, the track unit 132 may be of any suitable structures and operating mechanisms. In one or more embodiments, and as illustratively depicted in FIG. 1 through FIG. 3, the track unit 130 includes a leg portion 132 extending in the first direction “L” and a shoulder portion 134 extending in the second direction “W.” The shoulder portion 134 in turn contacts and moves relative to the leg portion 130. Along with the shoulder portion 134, the first and second holding wells 110, 120 retract into and open from the housing 150 at the retracted position and the open position, respectively.

The contact and relative movement between the leg and shoulder portions 132, 134 may be realized with any suitable methods, with non-limiting examples thereof including recess-and-roller mechanism wherein a recess (not shown) is provided onto the leg portion 132 to guide a roller (not shown) provided onto the shoulder portion 134.

Relative position between the first direction “L” and the second direction “W” may be determined and varied according to the particular housing to which the article storage system 100 is to be received. For instance, and as illustratively depicted in FIG. 1 through FIG. 3, the first direction “L” is perpendicular to the second direction “W” plus or minus 30, 20, 10 or 5 degrees or less.

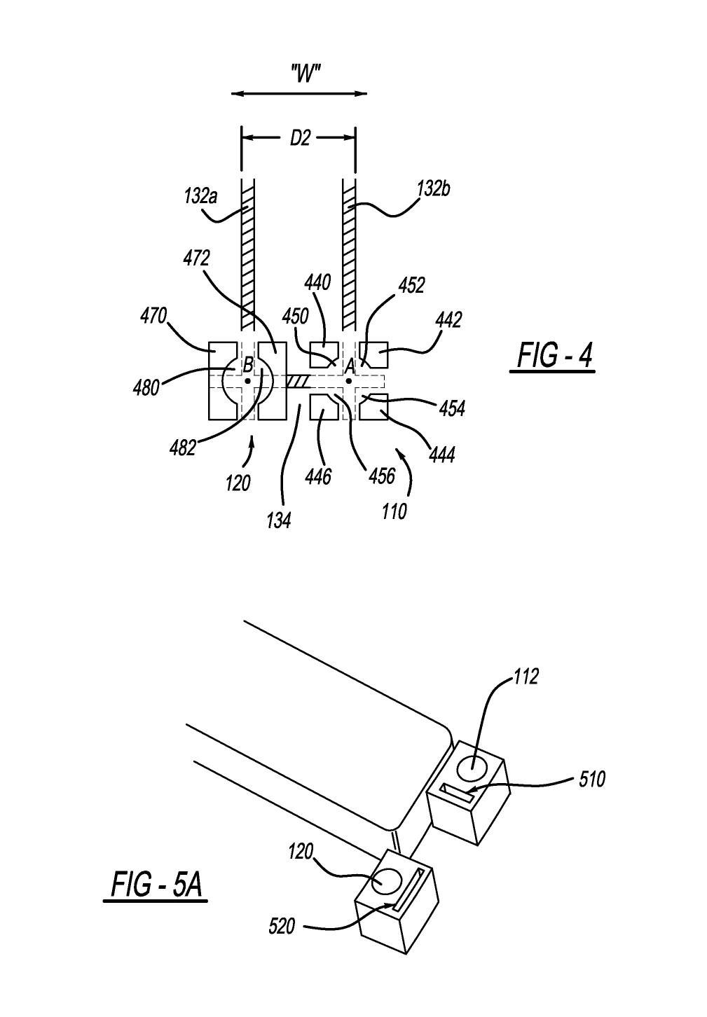

In certain embodiments, and as illustratively depicted in FIG. 4, the leg portion 132 may include two legs 132a, 132b together to support the shoulder portion 134. This configuration may provide enhanced weight distribution and movement stability, particularly when the first and second holding wells 110, 120 are to hold items that are of certain weight or volume.

Moreover, the legs 132a, 132b may be movable relative to each other along the second direction “W” such that they may be placed next to each other with no intended distance there between, or they may be spaced apart with a distance “D2” of any suitable value. The value of the distance “D2” may be limited by or varied with a width “D1” of the housing 150 as shown in FIG. 3. In this connection, the article holder system 100 is provided with additional flexibility to accommodate various types or sizes of housings in which the article holder system 100 may be employed.

The console 10 may further include an armrest cover 160 and a door 170 as illustratively depicted in FIG. 2. The door 170 may rotate about an edge 180. At the initially and extendedly open positions, the door 170 rotates about the edge 180 and is positioned underneath the first and second holding wells 110, 120. At the retracted position, the door 170 may rotate back to its upright position and closes in the entire article holder system 100 for space saving and against dirt accumulation.

The first and second holding wells 110, 120 may each independently be of any suitable shapes and be formed of any suitable materials. Non-limiting examples of the shapes include rounds, ovals, squares, rectangles, triangles, and any other suitable geometrical shapes.

Referring back to FIG. 1, the first and second holding wells 110, 120 include first and second cup-holding cavities 112, 122, respectively. The first and second cup-holding cavities 112, 122 may each present a closed-loop cross-section, such that the cup-holding cavities 112, 122 each have a maximum size allowance for the cross-sectional size of an incoming cup.

Alternatively, and as illustratively shown in FIG. 4, the first and second holding wells 110, 120 may each be formed of two or more sections which are closable and expandable to accommodate variations in cross-sectional dimensions of an incoming cup. For instance, as illustratively depicted in FIG. 4, the first holding well 110 may be formed of four separate sections 440, 442, 444, 446, each of which defining a cavity 450, 452, 454, 456. When the four sections 440, 442, 444, 446 merge toward center “A”, a collective cavity formed then by the cavity 450, 452, 454, 456 is of a standard holding size. Alternatively, and based on need, the four sections 440, 442, 444, 446 may move away from the center “A”, and a collective cavity formed then by the cavities 450, 452, 454, 456 is of an expanded holding size.

Similarly, the second holding well 120 is shown to have only two sections 470, 472, each with a cavity 480, 482. A collective cavity formed by the cavities 480, 482 may increase in holding volume as the sections 470, 472 move away from center “B”, and may decrease in holding volume as the sections 470, 472 move toward the center “B.”

The configurations illustratively shown in FIG. 4 do not have to be limited by the number of the sections for forming each of the holding wells. However, the structure by which each of the first and second holding wells 110, 120 may be expandable to accommodate cross-sectional sizes of an incoming cup is made possible in part by the track unit 130. As can be seen from the FIG. 1 through FIG. 4, the first and second holding wells 110, 120 are first caused to move along the leg portion 132 to reach an area outside of the housing 150 and to being at an open position. Once at this open position, each of the holding wells 110, 120 may optionally move away from each other to reach for a desirable clearance in space where sections of each of the holding wells may then expand away to create more room for an in-coming cup.

In certain embodiments, each of the first and second holding wells 110, 120 may be completely detachable from the track unit 130. One benefit of this configuration is that now instead of having each of the holding wells expand in holding capacity via moving its sections, one my opt for replacing a different holding well having different cup-holding cavity sizes all together. The detachment and re-attachment may be realized using any suitable methods, including clip-on structures or socket-ball structures readily available.

To provide additional space saving and design flexibility, the leg portion 132, the shoulder portion 134, or the legs 132a, 132b included in the leg portion 132 may each independently be configured as telescopic.

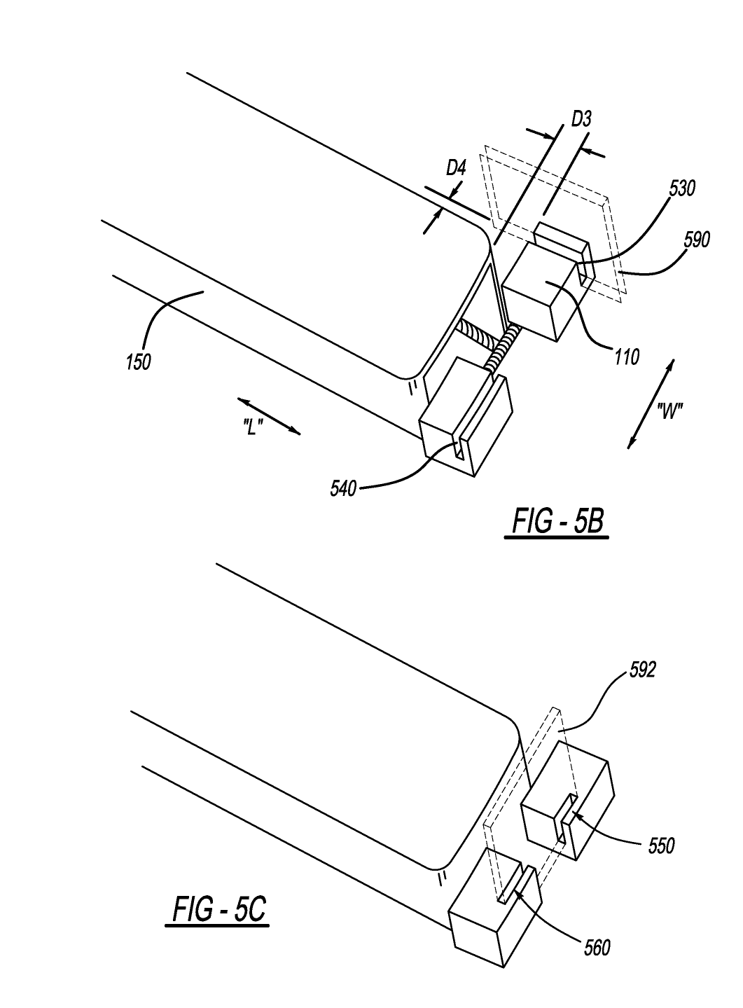

With the design flexibility detailed herein elsewhere, the article holder system 100 is well positioned to hold or store articles with certain particular shapes and sizes. For instance, and illustratively depicted in FIG. 5B, one or more holding slots 530 may be provided to the holding well 110. The one or more holding slots 530 may be positioned away from the housing 150 with a longitudinal distance of “D3” along the first direction “L” and a traverse distance of “D4” along the second direction “W”, wherein both distances “D3” and “D4” are adjustable via the track unit 130. In addition, the one or more holding slots 530 may be configured as a through-cut along the first direction “L” such that an article 590 with relatively greater dimensions may still fit in the holding slot 530.

Similarly, and as illustratively depicted in FIG. 5B, one or more holding slots 540 may also be provided to the second holding well 120, in any suitable orientations. Similarly also the one or more holding slots 540 may be configured as a through-cut along the second direction “W” to accommodate articles with certain dimensions.

Another variation to FIG. 5B may be illustratively depicted in FIG. 5C, wherein holding slots 550, 560 as respectively present on the first and second holding wells 110, 120 may collectively provide holding support for an even larger article 592, with non-limiting examples thereof including paper notepads, electrical notepads, books, magazines, and lightweight laptop computers.

Of course, and as illustratively depicted in FIG. 5A, storage slots 510, 520 with no side openings may be provided spaced apart from the cup-holding cavities. In these instances, the storage slots 510, 520 provide a secure storage place for articles with relatively small cross-sectional dimensions such as parking tickets and shopping cards.

In this connection, and as illustratively depicted in FIG. 1, the cup-holding cavities of the first and second holding wells 110, 120 may be made to each have an open-loop cross-section, such that the cup-holding cavities 112, 122 themselves together may form an enlarged holding cavity for any suitable articles.

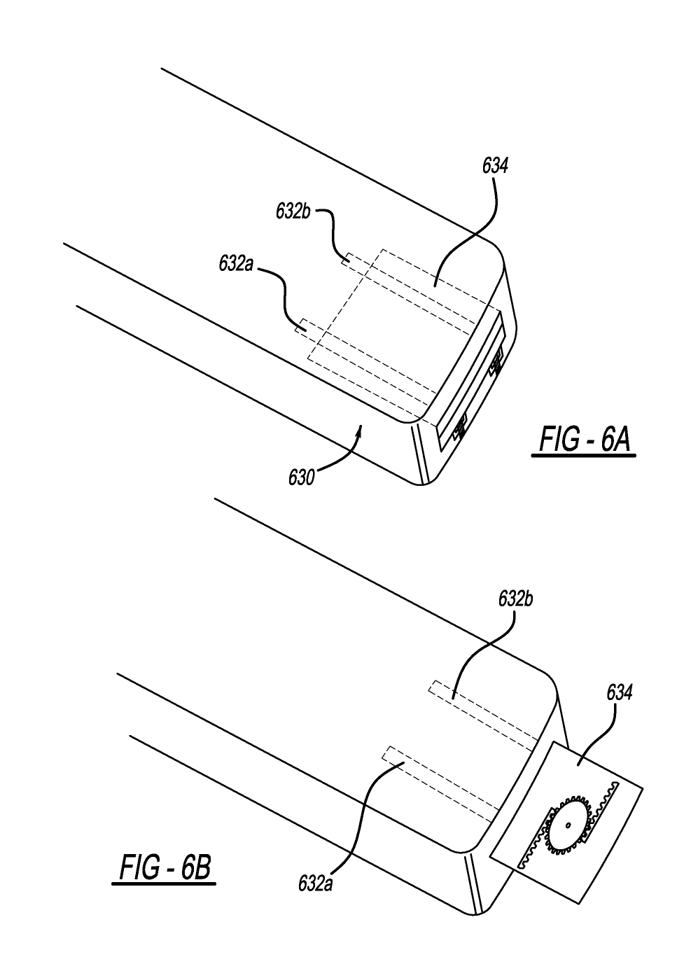

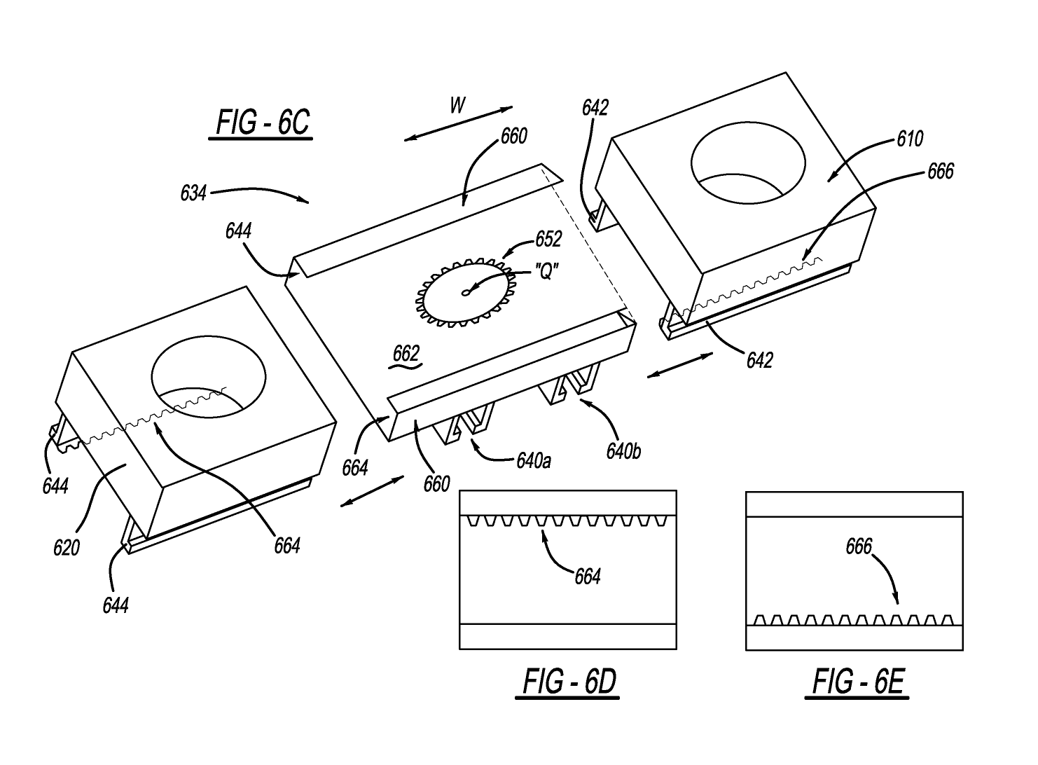

In yet another or more embodiments, and as illustratively depicted in FIG. 6A and FIG. 6B, a variation of the track unit 130 is generally shown at 630. In this variation, the track unit 130 includes a pair of legs 632a, 632b contacting and supporting movement thereof of a shoulder portion 634 which is generally depicted as a floor panel. Further in view of FIG. 6C, the shoulder portion 634 itself may include foot portions 640a, 640b to engage with and glide along the legs 632a, 632b, respectively, such that the shoulder portion 634 may move relative to the legs 632a, 632b so as to retract and extend.

The first and second holding wells 610, 620 may be engaged and aligned with the shoulder portion 634 via any suitable connections and mechanisms. For instance, and referring back to FIG. 6B and further in view of FIG. 6C, the first and second holding wells 610, 620 respectively include protrusions 642, 644 that are receivable to a recess 664 defined by a shoulder wall 660 of the shoulder portion 634. With this arrangement, the first and the second holding wells 610, 620 may readily move along direction “W” to reach various extendedly open positions.

Optionally, and as illustratively depicted in FIG. 6C and further in view of FIG. 6D, FIG. 6E, relative movement between the first and second holding wells 610, 620 may be collaborated via the employment of one or more gears or gear set. In this arrangement, the first holding well 610 is movable relative to the shoulder portion 634 via engagement or disengagement of a gear set including gears 652 and 666. Similarly, the second holding well 620 is movable relative to the shoulder portion 634 via engagement or disengagement of gears 652 and 664. In this arrangement, the shoulder wall 660 and/or the gear 652 may be positioned on one side of the shoulder portion 634, and the foot portions 640a, 640b may be positioned on an opposing side of the shoulder portion 634.

Referring back to FIG. 6C, the gear 652 may be attached to a bottom 662 of the shoulder portion 634 and may optionally be fastened with suitable connectors such as one or more screws via a hole “Q” on the bottom 662.

Although two legs 632a, 632b and corresponding two foot portions 640a, 640b are shown in the depictions referenced in FIG. 6A through FIG. 6C, such a two leg construction is not necessary for not limiting to the leg portion 132 discussed herein elsewhere. The embodiments illustratively depicted in FIG. 6A through FIG. 6C may be realized via the two leg construction for the leg portion 132, may be three or more, or merely one leg construction, as long as the leg portion 132 supports and facilitates the movement of the shoulder portion 634 as mentioned herein elsewhere.

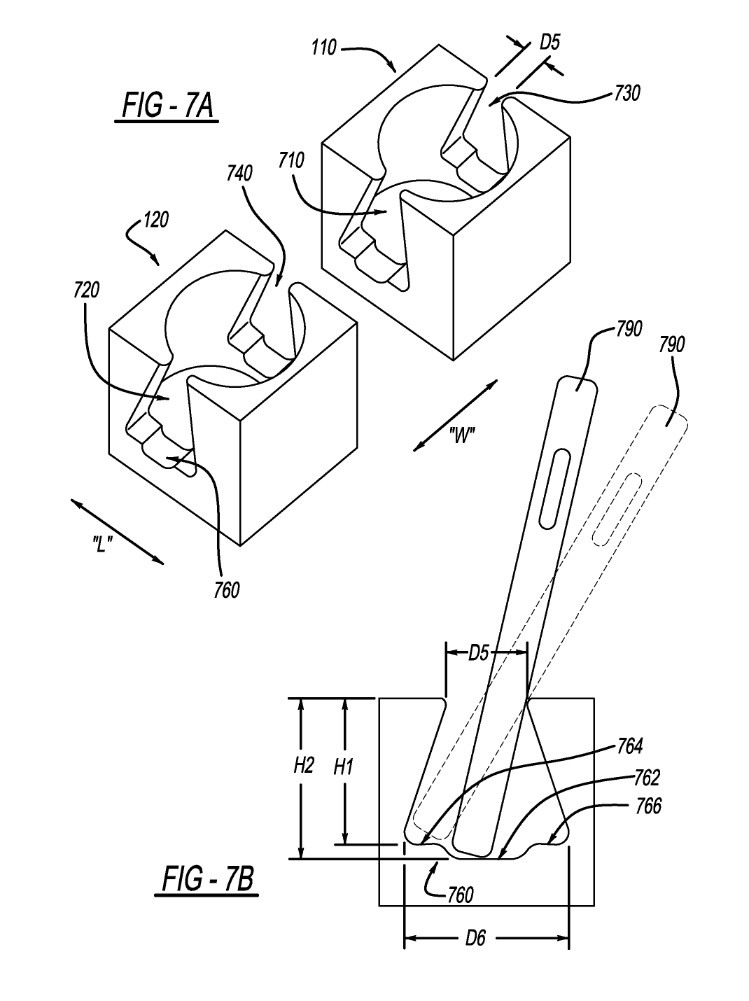

In one or more embodiments, and as illustratively depicted in FIG. 7A and FIG. 7B, the first holding well 110 may be provided with a pair of storage slots 710, 730 on opposing sides thereof along the second or transverse direction “W.” Optionally, the second holding well 120 may also be provided with a pair of storage slots 720, 740 on opposing sides thereof along the second or transverse direction “W.” A common feature of the storage slots 710, 720, 730 and 740 is that a cross-section thereof includes, as illustratively depicted in FIG. 7B, a relatively narrow upper opening with a cross-sectional dimension of “D5” and a relatively wider lower opening with a cross-sectional dimension of “D6.” Another common feature includes a stepwise floor 760 which includes a center portion 762 positioned between two side portions 764 766, the center portion 762 having a relatively greater depth “H2” and the side portions 764, 766 each having a relatively smaller depth “H1.” In this arrangement, the center portion 762 and the two side portions 764, 766 collectively define the stepwise floor which is believed to further enhance the article holding capacity of the first and second holding wells 110, 120. For instance, and as illustratively depicted in FIG. 7B, an object 790 such as a cell phone, a thin-pad computer, a book or a magazine may be positioned stably against the center portion 762 or the side portion 764, 766 of the stepwise floor 760. The stability is further enhanced when the object 790 is positioned using both the storage slots 710, 730 of the first holding well 110, or the storage slots 720, 740 of the second holding well 120. In certain instances, center portion 762 and the side portions 764, 766 may collectively form a smooth curve such as a half circle in replacement of the stepwise floor depicted in FIG. 7B.

Alternatively the structures of the storage slot 740 and 710 may be simplified, for instance as not necessarily requiring the cross-sectional features depicted in FIG. 7B and in particular not requiring the stepwise floor 760, such that the object 790 is in general held by the storage slots 730 and 720. This design is similar in spirit to the one illustratively depicted in FIG. 5C, where a collective holding cavity is defined by both of the first and second holding wells 110, 120, yet with the added stability for certain objects to be stored. Although the first and second holding wells 110, 120 are each shown in FIG. 7A with a pair of storage slot 710, 730, 720 and 740 having the cross-section depicted in FIG. 7B, the number or the position of such a storage slot is not limiting. In other words, the first and second holding wells 110, 120 may be provided at any suitable side walls thereof with one, two or more of the storage slot having the cross-section shown in FIG. 3B.

In one or more embodiments, the present invention as set forth herein is believed to have overcome certain challenges associated to article holding and storage particular to a vehicle environment. However, one skilled in the art will readily recognize from such discussion, and from the accompanying drawings and claims that various changes, modifications and variations can be made therein without departing from the true spirit and fair scope of the invention as defined by the following claims.

What is claimed is:

1. An article holder system, comprising:
a track unit;
first and second holding wells supported on the track unit and movable along a first direction between a retracted position and an initially open position, at least one of the first and second holding wells movable between an extendedly open position and the initially open position along a second direction different than the first direction.

2. The article holder system of claim 1, wherein the track unit includes a leg portion supporting movement along the first direction and a shoulder portion supporting movement along the second direction.

3. The article holder system of claim 2, wherein the leg portion includes two legs supporting the shoulder portion.

4. The article holder system of claim 3, wherein the two legs are movable relative to each other along the second direction.

5. The article holder system of claim 2, wherein at least one of the leg and shoulder portions is telescopic.

6. The article holder system of claim 2, wherein the shoulder portion includes a floor panel having two opposing sides, with one of which contacting the first and second holding wells and the other contacting the leg portion.

7. The article holder system of claim 1, wherein at least one of the first and second holding wells includes a cup-holding cavity for holding a drinking cup and a storage slot spaced apart from the cup-holding cavity.

8. The article holder system of claim 7, wherein the storage slot is open to exterior on at least one side thereof.

9. The article holder system of claim 1, wherein at least one of the first and second holding wells includes a side wall defining a storage slot, a cross-section of the storage slot including a relatively smaller upper cross-sectional dimension and a relatively greater lower cross-sectional dimension, and the cross-section of the storage slot further including a stepwise floor which includes a center portion positioned between two side portions, the center portion having a relatively greater depth and the two side portions each having a relatively smaller depth.

10. The article holder system of claim 7, wherein the first and second holding wells respectively include first and second storage slots, each of which having an opening facing each other to form a collective storage slot.

11. The article holder system of claim 1, wherein at least one of the first and second holding wells is detachable from the track unit.

12. The article holder system of claim 1, wherein at least one of the first and second holding wells includes two or more sections movable relative to each other in creating an expandable article-holding volume.

13. The article holder system of claim 1, wherein at least one of the first and second holding wells includes an open-loop cross-section.

14. A storage console of a vehicle, comprising:
a housing;
a track unit connected to the housing and including leg and shoulder portions; and
first and second holding wells supported on and movable relative to each other along the shoulder portion.

15. The storage console of claim 14, wherein the shoulder portion includes a floor panel having two opposing sides, with one of which contacting the first and second holding wells and the other contacting the leg portion.

16. The storage console of claim 14, wherein the leg portion includes two legs supporting the shoulder portion.

17. The storage console of claim 16, wherein the two legs are movable relative to each other.

18. The storage console of claim 14, wherein at least one of the leg and shoulder portions is telescopic.

19. The storage console of claim 14, wherein at least one of the first and second holding wells is detachable from the track unit.

20. An article holder system, comprising:
a housing;
a track unit connected to the housing and including leg and shoulder portions; and
first and second holding wells supported on and movable relative to each other along the shoulder portion,
wherein the shoulder portion includes a floor panel having two opposing sides, with one of which contacting the first and second holding wells and the other contacting the leg portion, and wherein at least one of the first and second holding wells is detachable from the track unit.
